(19) United States
(12) Patent Application Publication
(10) Pub. No.: US 2006/0155636 A1
(43) Pub. Date: Jul. 13, 2006

(54) Method and system for recruiting for employee positions and employees bidding for the same

(75) Inventors: John Michael Hermann, Newport Coast, CA (US); Robert William Long, Coto De Caza, CA (US); Chas R. Patterson, Irvine, CA (US)

Correspondence Address: GREENBERG-TRAURIG, 1750 TYSONS BOULEVARD, 12TH FLOOR, MCLEAN, VA, 22102, US

(73) Assignee: Swallows, LLC, Newport Beach, CA (US)

(21) Appl. No.: 11/159,409

(22) Filed: Jun. 23, 2005

Related U.S. Application Data
(60) Provisional application No. 60/581,728, filed on Jun. 23, 2004.

(51) Int. Cl. G06Q 40/00

(52) U.S. Cl. 705/37

(57) ABSTRACT

This method and system provides for an organization to electronically post an open position and for potential candidates to bid on those positions through the use of a “blind bid” system. In addition, the system allows organizations to query a database for potential candidates and directly invite them to bid on available positions, or directly request them to fill available positions for a specified hourly wage rate. The system is highly automated and efficient, requiring far less human interaction to recruit potential candidates. The system also utilizes modern technology such as e-mail, text messaging and the Internet to lessen the need to place recruitment advertisements in traditional media. Qualified candidates are able to quickly find positions and place a bid to fill that position. The candidate registers on the system and submits a requested wage rate with the bid such that the organization may compare the candidates' requisite qualifications and wage rates and choose the candidate that is acceptable to the hiring organization.

This application claims the benefit of U.S. Provisional Patent Application No. 60/581,728 filed Jun. 23, 2004, the entire disclosure of which, including the appendix, is incorporated herein by reference.

### FIELD OF THE INVENTION

The present invention relates to the field of employee placement both internally and externally, and more particularly an automated method and system for placing candidates by bidding for open employment positions and for employers to proactively search and bid for potential candidates.

### BACKGROUND OF THE INVENTION

When an organization has a need to fill an employment position, whether full time or part time, conventional means of recruiting are somewhat slow and burdensome. In one conventional means, an organization with an open position advertises the position in a newspaper and/or trade journal. Often, the position is only temporary, such as the need for a nurse to work only a few open shifts or a few hours. Additionally, in a large organization with constant turnover of employees or constant needs to fill open permanent and temporary positions, advertising the positions is too inefficient and only moderately effective. A representative of the organization must use considerable time to post and repost advertisements, as well as reply to those candidates who show interest in the open positions. Further, the method of using both internally and externally published advertisements does not reach a large enough portion of the intended pool of candidates. In some situations, a recruiting agency, or “registry,” may be employed to assist in recruiting candidates and advertising available positions.

The recruiting agency, or “registry,” is similarly limited in ability to quickly disseminate the information regarding availability and then retain a sufficiently extensive pool of qualified candidates. Recruiting agencies, or “registries,” typically spread information through telephone calls and advertisements similar to the methods of the hiring organization. These methods are limited as the recruiting agency/registry must spend a large amount of time and funds to recruit for a position that may need to be filled rather quickly. When an interested candidate is located, the recruiting agencies/registries encourage the candidates to apply for the position. However, the candidate's qualifications must be reviewed and matched by the recruiting agency and the hiring organization before a decision is made to interview and ultimately hire the candidate.

After interviewing a number of candidates, the organization decides which candidate is most qualified for the position, based on experience and salary. Ideally, the organization would like to hire the most experienced candidate at the lowest possible salary. Upon reviewing resumes and conducting interviews, the organization becomes aware of the most qualified candidates. The organization must also address salary or payment for the position.

In another conventional means, candidates may negotiate with the organization to receive the highest possible salary. In a “sellers” market, the candidates may be satisfied with the offered salary, rather than negotiating for a higher amount. In such a market, however, the organization would prefer to hire the qualified candidate that is willing to work for even less than the other qualified candidates.

### SUMMARY OF THE INVENTION

The present invention provides a method and system for an organization to recruit candidates for an open employment position and have the candidates bid for the position. In addition, the system allows an organization to query a database of qualified candidates that meet their needs and either invite them to apply and bid for open positions, or the organization may offer a specific candidate a best and final bid rate to fill a given position. The system is highly automated and efficient, requiring little human interaction to contact and recruit potential candidates.

The system also utilizes modern technology such as e-mail, text messaging, video conferencing and the Internet to lessen the need to place advertisements in newspapers. Since a majority of the candidates have access to e-mail, text messaging devices or the Internet, a larger pool of candidates is obtained. Additionally, through the use of such electronic means, recruiting processes such as posting an open position or evaluating candidate qualifications are substantially faster and more efficient than conventional means. Qualified candidates are able to quickly find positions and place a bid. Likewise, organizations are able to post many positions and select qualified candidates in a matter of minutes. In addition, organizations are able to reach out to potential candidates through the electronic invitation (“e-Vite”) function and actively invite them to bid for open positions, or the “Direct Request” function and offer a best and final hourly wage rate to a selected candidate to fill an open position. The organization may also reach out to potential candidates via a “Quick Job” function to offer the best and final hourly wage rate to selected candidates and the first to electronically accept the offer wins the job.

Because it utilizes a “blind bid” process (candidates are only able to view their own bids), the present invention also provides a method for an organization to choose a candidate with the desired qualifications and with a substantially lower salary requirement than other qualified candidates. This eliminates the need for salary negotiations with qualified candidates. In this method, the candidate submits a requested bid rate for which they are willing to work, thus allowing the hiring organization to compare the candidates' bid requirements and choose the candidate that best satisfies the organization's criteria (e.g., lowest bid, skill level, years of experience, proximity, etc). This “blind bid” process creates an automated platform, which by design and implementation, automatically determines the market value of any organization's part-time, full-time or shift work positions. Much as water seeks its own level, this “blind bid” process will provide a dynamic environment for the “market value” of a given position to seek its own level. The invention creates a market value for “human capital” and allows for the automated transaction of that capital, similar to the manner in which the Stock Market determines the value of the stocks that it transacts.

The present invention also provides cost savings for the organization. By utilizing the system of the present invention, an organization saves a significant cost by reducing the need for conventional recruiting means. The candidates also benefit by receiving a wage rate and shift preference that is satisfactory to them. Because of the “blind bid” process, the candidates may submit bids that are higher, lower, or the same as market averages based upon their evaluation of their worth, their desire to work a specified shift at a specified location, or any number of other factors. Ultimately, candidates are able to name the price for which they are willing to work and employers are free to agree with and accept the candidate or disagree and decline the candidate.

It is to be understood that both the foregoing general description and the following detailed description are exemplary and explanatory and are intended to provide further explanation of the invention.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a diagram illustrating the system for a candidate according to an embodiment of the present invention.

FIG. 2 is a diagram illustrating the system for an organization according to an embodiment of the present invention.

FIG. 3 is a diagram of the bidding process for a candidate according to an embodiment of the present invention.

FIGS. 4a and 4b are diagrams illustrating the job renewal procedure according to an embodiment of the present invention.

FIG. 5 is a diagram of the interaction between the system, the candidate, and the organization according to an embodiment of the present invention.

FIG. 6 is a diagram illustrating a Quick Job process flow according to an embodiment of the present invention.

FIGS. 7(a) and (b) are diagrams illustrating a Direct Invitation process flow according to an embodiment of the present invention.

FIG. 8 is a diagram illustrating a Direct Request process flow according to an embodiment of the present invention.

FIGS. 9a and 9b are tables showing examples illustrating a process for multiple hospitals to bid on a candidate.

FIGS. 10-18 are screen shots illustrating a system of the invention from the user interface perspective.

### DETAILED DESCRIPTION OF THE PREFERRED EMBODIMENTS

Reference will now be made in detail to the preferred embodiments of the present invention, examples of which are illustrated in the accompanying drawings.

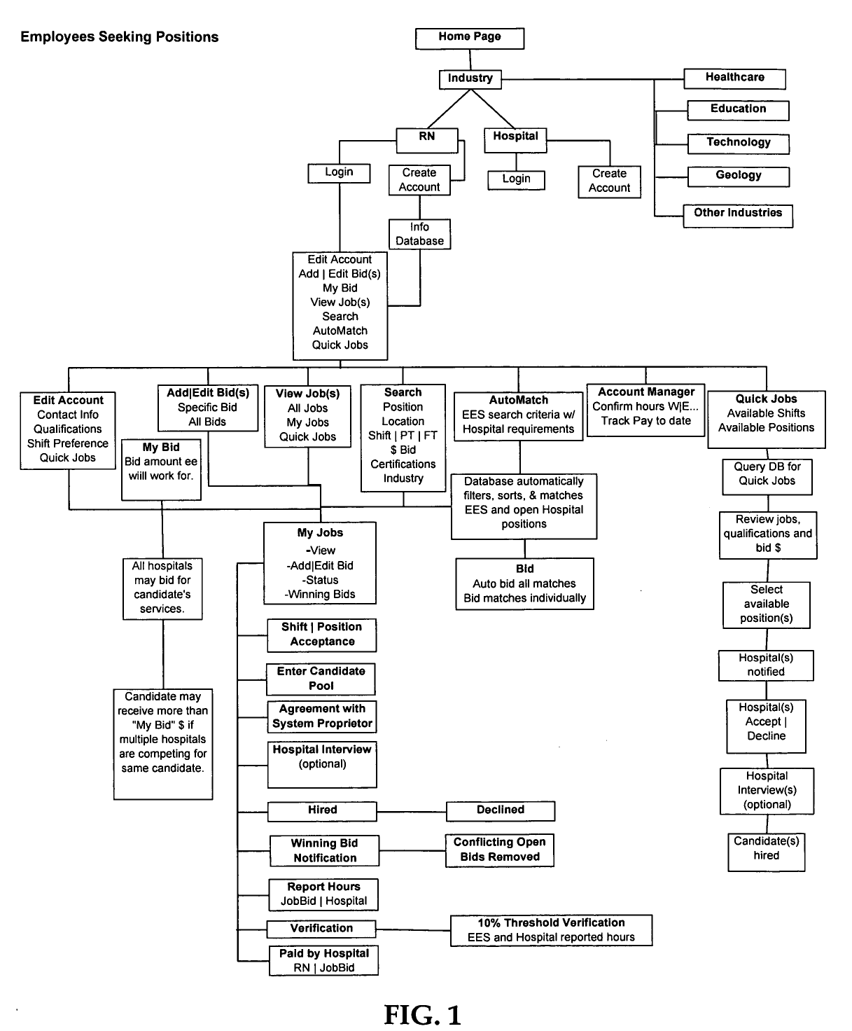

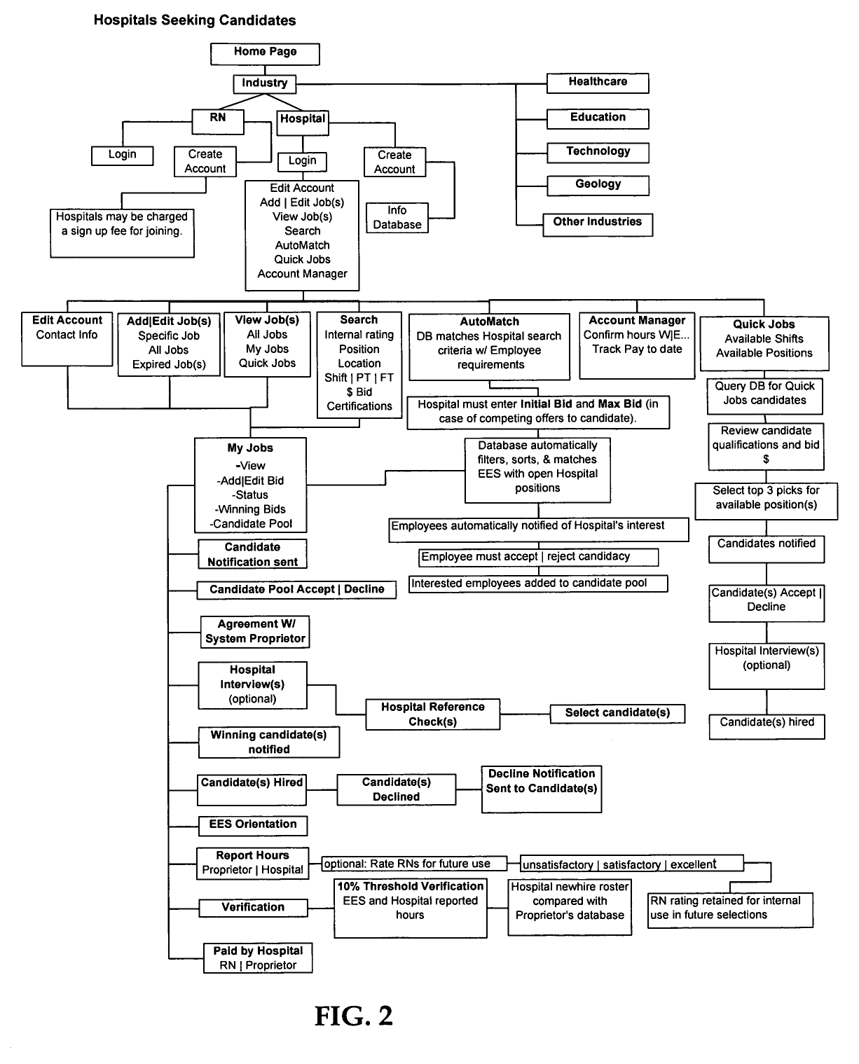

Referring to FIG. 1, a block diagram illustrating the system of the present invention is shown. The system may be used for any industry seeking to fill employee positions including, but not limited to, healthcare, education, technology, geology, legal services, and all others. The exemplary embodiment of FIG. 1 relates to the healthcare industry. A hospital creates an account according to the present invention through a website. The hospital logs into the system and lists current openings for permanent or temporary full-time, part-time and shift work positions, such as a Registered Nurse (“RN”). The method for an organization to post an open position and select candidates is further disclosed herein in FIG. 2.

Referring to FIG. 2, the process of an organization selecting a candidate for an open position is shown. The organization utilizes the system to obtain employees by two different methods. In a first method, the organization posts a position for a specified bid rate or range. In a second method, the organization can proactively search the database of employees and select potential candidates to contact and solicit to bid for positions. The candidates may then be contacted for interviews.

The organization creates a user account on the system. The organization logs in to the system to access their account, which contains BFOQs (Bona Fide Occupational Qualifications) and preferences for pending positions and search options for new positions. Preferably, a representative of the organization, such as a human resources representative, manages the organization's account, job postings and BFOQs, reviews candidate qualifications and interviews candidates. The invention was created to be an automated transactional system.

A candidate seeking open positions or shifts in their preferred field of employment also creates a user account on the system of the present invention. The account contains personal information and is stored in the system's database. Personal information includes contact information, qualifications, shift preferences, availability, etc. After creating the user account, the candidate logs into the system to edit the account, add or edit bids, view jobs, or search for jobs.

The candidate may edit the account, wherein the candidate's contact information may be updated. Further, the candidate may update listed qualifications, for example, if the candidate has recently received a certification that will enable the candidate to qualify for other positions. The candidate may also indicate or change shift preferences. For example, the candidate may choose to work nights to accommodate for a current job during the day.

Within the candidate's personal information is a base bid rate for which they are willing to work and their current bid rates for open positions. Employers provide an acceptable bid range for each position, which candidates do not see, but is used as selection criteria for the position. For example, if the range is $10.00-$30.00 per hour, only bids within that range will be accepted. Candidates bid for the position according to their perceived market value. The employer determines the hiring priorities for each position and ranks qualifications, education, bid rate, key work match in order of importance. The employer then selects the candidate accordingly. Assuming the candidate's qualifications are acceptable to the organization, the lowest bidding candidate will be more likely to be hired for the position. Conversely, candidates may bid higher than what they believe others are bidding because they feel their skills and experience justify the higher bid amount. These bids are “blind bids,” however, meaning that a candidate is not aware of the amount or, even the presence of another candidate's bid. The candidate may add or edit a specific bid or all bids in their user account. To bid on an open position, the candidate indicates a preferred salary or wage rate per hour.

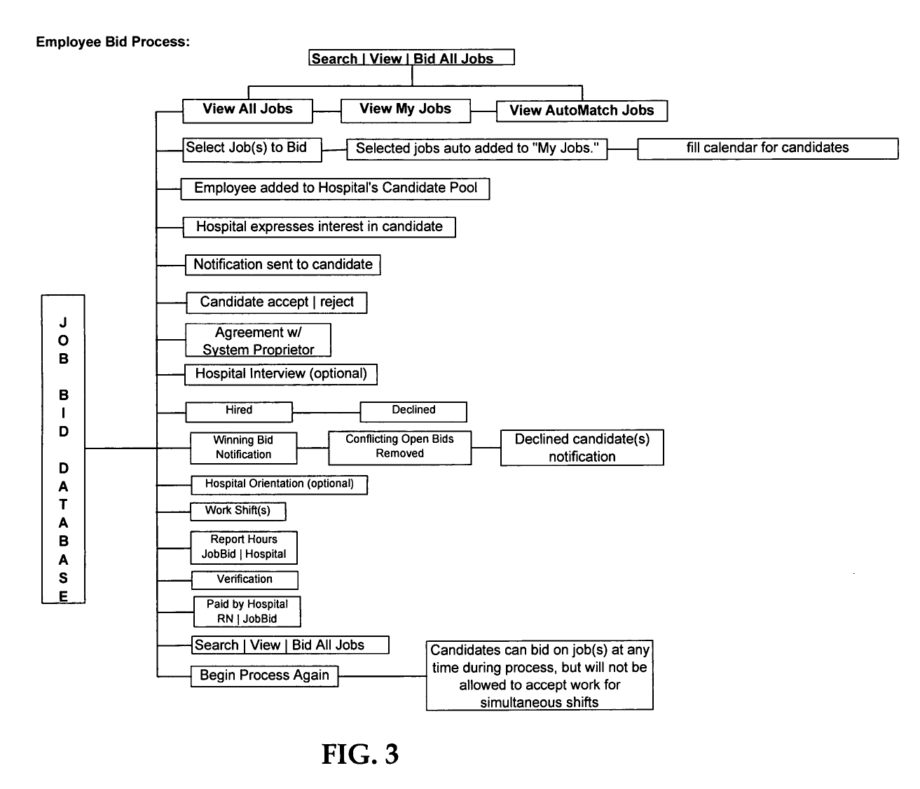

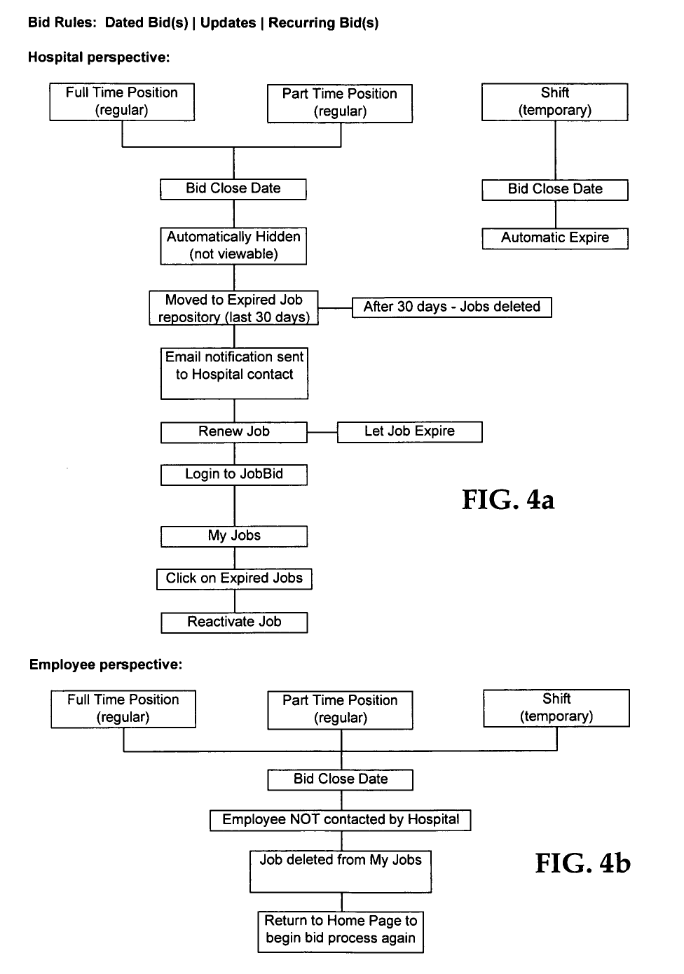

The candidate may search and bid for open positions and shifts, as further exemplified in FIGS. 3 and 4. Search criteria may include one or a combination of any of the following criteria including the industry, specialty area, availability, and/or employer.

Alternatively, the candidate may search using the AutoMatch feature. AutoMatch compares the candidate's search criteria with the organization's requirements. In the exemplary embodiment, the RN's criteria is automatically searched and identified along with a hospital's requisite requirements for the open position. The system automatically filters, sorts, and matches RNs with the open positions at the hospital. The RN candidate may then bid on each position and/or shift identified by the system. Once the candidate submits his/her bids, they will soon be automatically notified of the hiring hospital's interest.

Within the user account, the candidate can also view all open positions and shifts, or positions saved by the candidate under the “My Jobs” folder. Within the “My Jobs” folder, the candidate may further view the status of their pending bids.

A deadline exists for bids to be submitted to the system. Referring to FIG. 4, upon the bid close date, no further bids will be accepted and the open position will no longer be viewable in searches. The posted position is moved to an “Expired Job” repository for a specified period of time determined by the hiring organization. After that specified period, the position is deleted from the database. Before deletion of the position, a notification is sent to the organization's contact asking for renewal of the position or deletion of the position. For example, before deletion of a position for an RN position, the system sends an e-mail notification to a hospital contact asking whether to delete the position or renew the position after the expiration of the predetermined repository period.

The position may be automatically renewed for a predetermined period before it is set to expire again. The organization's contact renews the position by logging in to the system and reactivating the position in “Expired Jobs.”

Candidates are notified if they are selected to enter the candidate pool of finalists for the position or shift. Candidates that accept are added to the final pool of candidates for an interview or further scrutiny.

Some candidates are not selected for open positions. After the bid close date, the listing for the position is deleted from the candidate's “My Jobs” folder and the candidate may continue with the bidding process for other available positions.

A user agreement between the organization and the candidate must be accepted. The user agreement stipulates, in part, that if a cause-effect relationship exists between the organization hiring a part-time, full-time, or shift work position, the organization is obligated to pay the proprietor of the system of the invention (referred to herein as the “system proprietor”) a certain percentage of the candidate's hourly rate for every hour worked. Other arrangements may be made regarding the percentage of salary and the timing of position acceptance.

The organization may elect (or not) to check the references and/or backgrounds of candidate “finalists.” Premium clients may elect for the system proprietor to conduct reference and background checks for candidates they have selected for their final candidate pool. If the system proprietor is elected to conduct reference and background checks, an Account Executive with the system proprietor may submit the client's “finalists” for checking through the appropriate party; results will then be reported back to the Account Executive who will then contact the client (hiring employer), notifying them of the results.

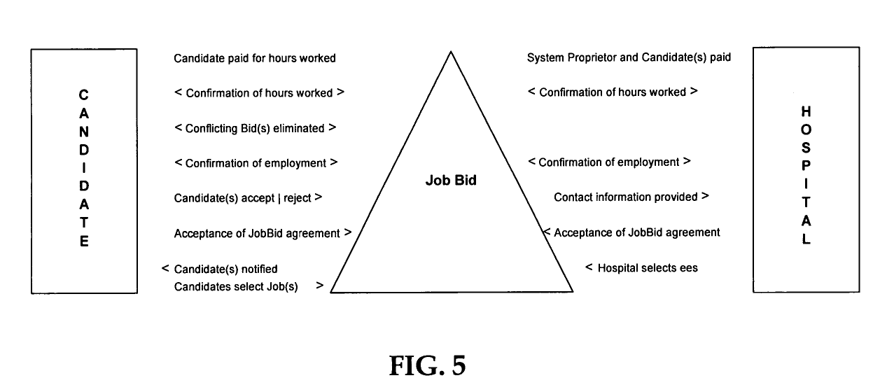

The organization may interview the candidates in the candidate pool at its discretion. Besides the interview itself, however, all interaction between the candidate and the organization is transacted through the system, as further exemplified in FIG. 5.

After interviewing the candidate, the organization may hire the candidate with the lowest bid, highest bid or other preferred criteria with or without conducting an interview. Ultimately, the organization makes a decision on whether or not to hire a candidate.

When the candidate is awarded a winning bid, i.e., the organization decides to hire the candidate, the candidate receives a notification, which may be in the form of an e-mail, telephone call, facsimile, etc. The candidate receives notification of the winning bid in “My Confirmed Jobs.” Upon notification of a winning bid, the database removes all other pending bids submitted by the candidate that conflict with the winning bid. If a winning bid is scheduled for the same shift as a pending bid, or overlaps in time with the pending bid, the pending bid is removed from the system to eliminate any scheduling conflicts.

The system confirms that the hours reported by the organization match the hours scheduled in the system of the invention, thereby ensuring that payments to the system proprietor have been properly calculated. The system proprietor may the right to periodically audit employer payroll records in order to compare the employer's payment(s) to specific employees, identified by Social Security Numbers (SSN), that were hired through the system.

This verification process may be subject to a ten percent failsafe threshold, which requires that the employer's reported hours are within ten percent of the hours reported by the system. The organization pays the employee directly during their normal payroll periods and a predetermined percent share of the employees' hourly rate is wire transferred to a bank account associated with the system proprietor. By contract, this wire transfer will be made the same day as normal payroll distribution to employees. If the hours do not match, a discrepancy report is sent to the organization and a routine payroll audit may occur (such an audit will match the employer's payments to specific employee SSNs against the SSNs of candidates in the system. The organization will then report the adjusted hours for payment and confirmation. By contract, adjustments should be made by the next normal payroll period.

Referring to FIG. 5, the system of the present invention provides substantially for all of the communication between the candidate and the organization prior to an interview. For example, if the organization selects a candidate for the final candidate pool, the system notifies the candidate who then informs the system whether the candidate has accepted or rejected placement into the final pool. After the candidate accepts placement into the final candidate pool, the system provides their contact information to the organization. The system may also require acceptance of user agreement by both the candidate and the organization. The system confirms employment of the candidate by the organization by sending a follow up email confirming which of the candidates in the final pool have been selected for positions/shifts. Winning candidates are then notified by the system. By prior hospital user agreement, the hospital will allow a monthly audit of all employee hours worked by candidates to ensure that all hired candidates have been properly reported.

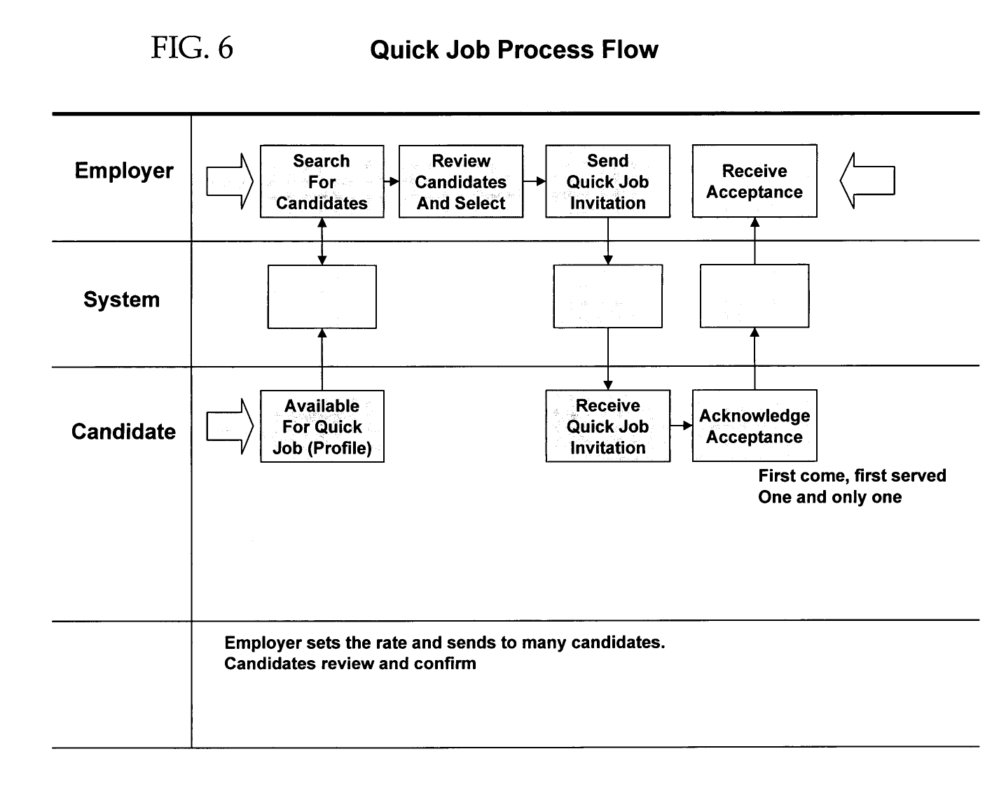

Referring to FIG. 6, a diagram of the “Quick Job” process is shown. Quick Job is the process by which a hiring organization may select a candidate for a “same day,” “next day,” or otherwise timely shift opening. When creating a user account, candidates will have the option of electing to be available for Quick Jobs during specified days, time periods, etc. Organizations may then query the system for candidates available for the time period they desire. The hiring organization then issues a best and final bid rate offer (with the understanding that the rate will likely be higher than an average bid rate because of the time sensitivity the position fulfillment requires). The bid will go to all available Quick Job candidates and the first qualified candidate to accept, will be awarded the Quick Job.

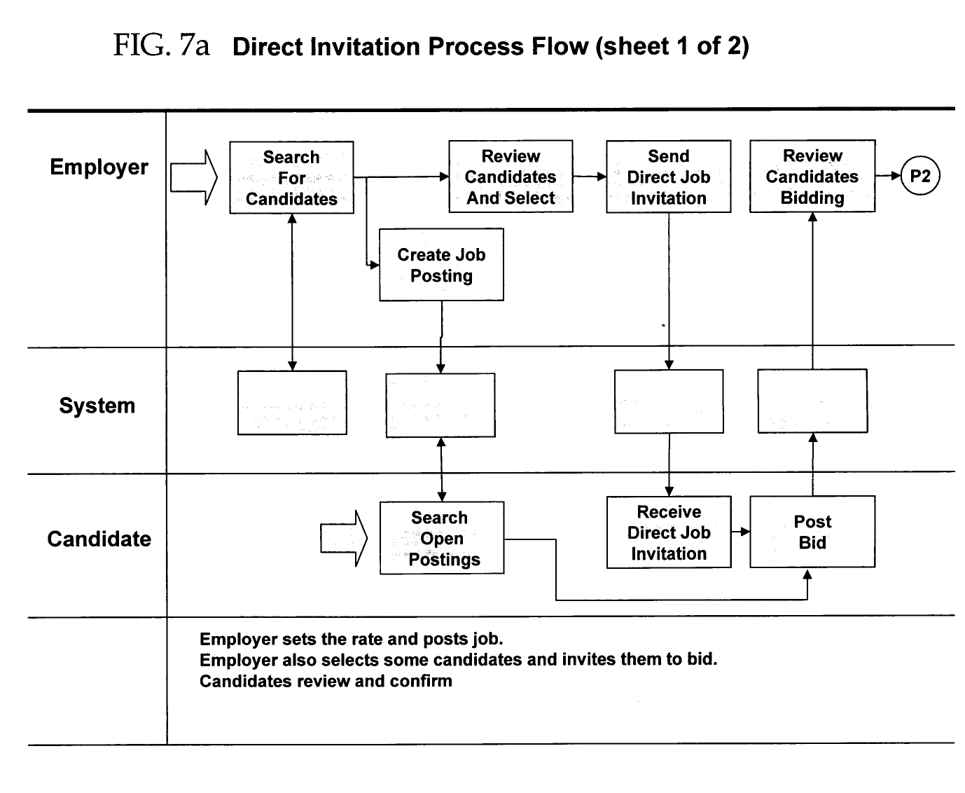

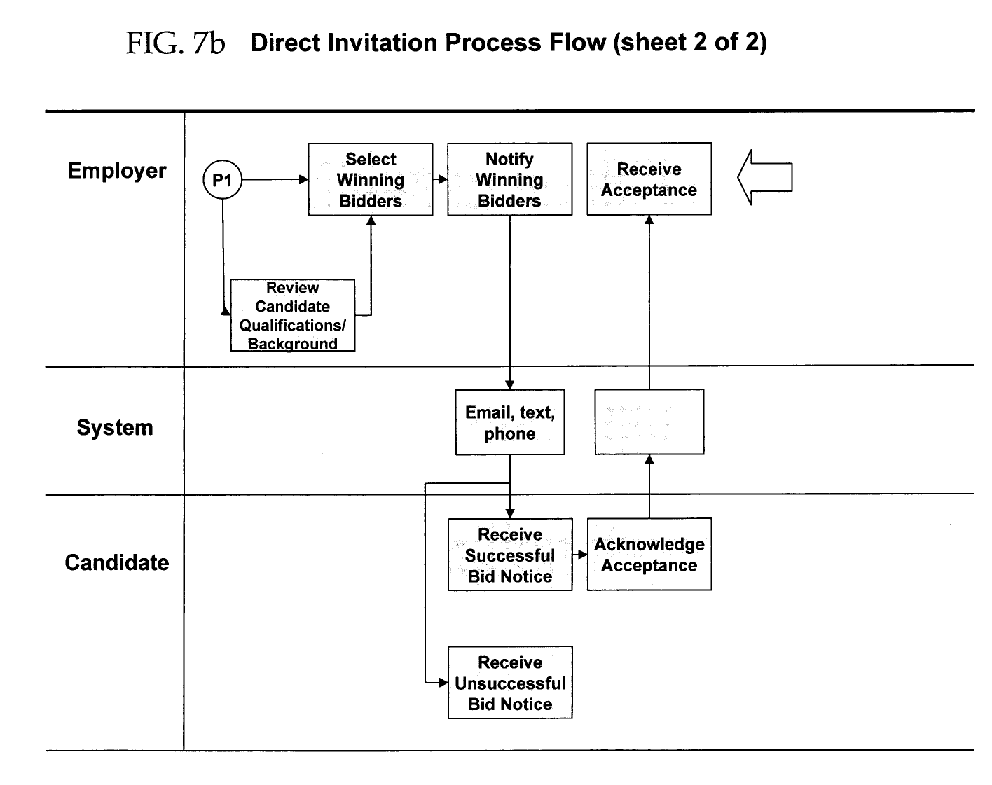

Referring to FIGS. 7(a) and (b), a diagram illustrating the “e-Vite” process is shown. e-Vite is a process whereby an employer can invite a specific candidate to fill a position. For example, if a candidate has worked satisfactorily for an organization in the past, the organization may simply wish to use that candidate again. Through the e-Vite tool, the organization can send an invitation to bid to a specific candidate, complete with job description, shift times and day(s), essentially bypassing the bid process. A Candidate can indicate in his user profile that he desires to receive e-Vite notifications via e-mails or text messages on his phone, PDA, pager, or other communication means. Thereafter when an employer has identified that candidate as a potential candidate for a position, the employer can cause the system to send the candidate message via that communication means indicating that the employer has invited the candidate to bid on. The employer may identify such candidates by, e.g., searching or otherwise reviewing the user profiles of candidates registered on the system. This gives the employer a proactive tool for locating candidates as an alternative to or in addition to simply posting the job on the system and waiting for qualified candidates to find the position.

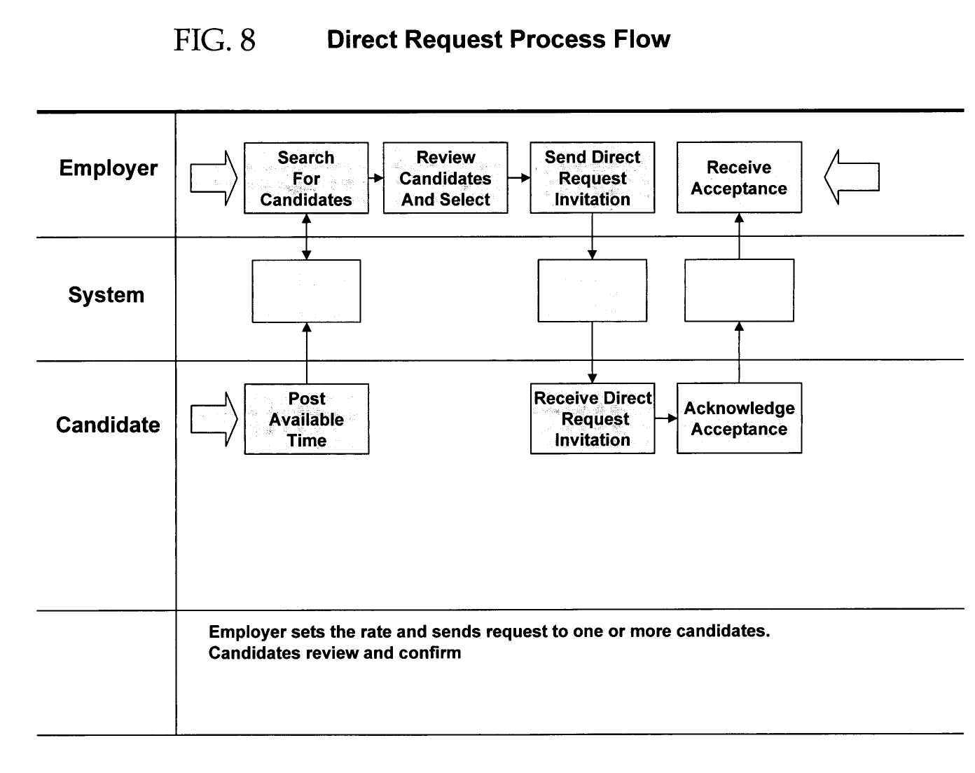

Referring to FIG. 8, a diagram illustrating the “Direct Request” process is shown. Direct Request is the process whereby an employer can offer a specific position to a specific candidate for a specified hourly wage rate. For example, if a candidate has worked satisfactorily for an organization in the past, the organization may simply wish to use that candidate again. Through the Direct Request tool, the organization can send an offer to a specific candidate, complete with job description, bid rate, shift times and day(s), etc.

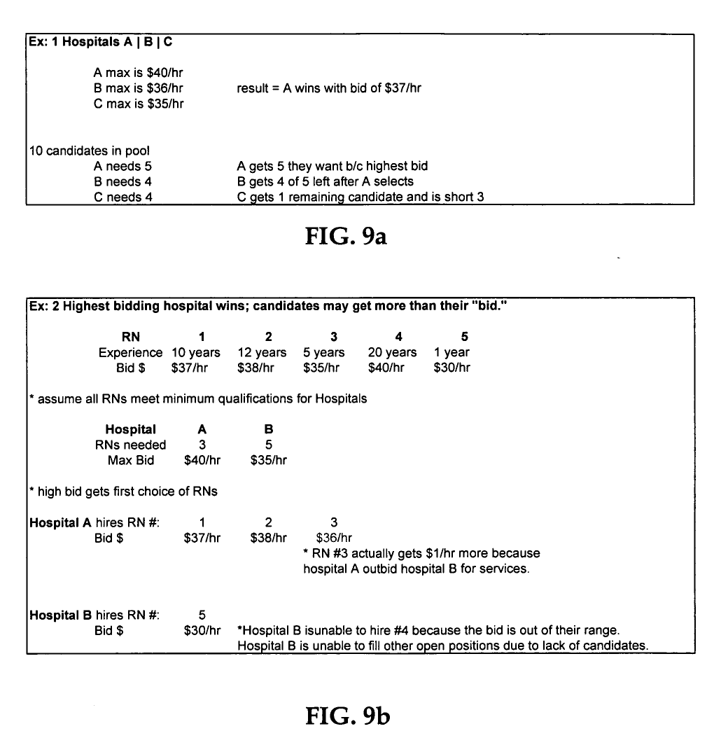

FIGS. 9a and 9b are tables showing examples illustrating a process for multiple employers to bid on a candidate. If a candidate lists a bid representing the wage for which he is willing to work in his profile, employers can query the database in the system of the invention to identify and make offers to such candidate. The system then allows the candidate to indicate acceptance of one or more of such offers.

The system of the invention may be practiced via a web server and backend database software. The software loaded into the web server, and various modules and applications supporting the same, can be programmed in Microsoft's ASP.NET language, interacting with Microsoft SQL databases. This may be supplemented by JavaScript applications for enhanced functionality.

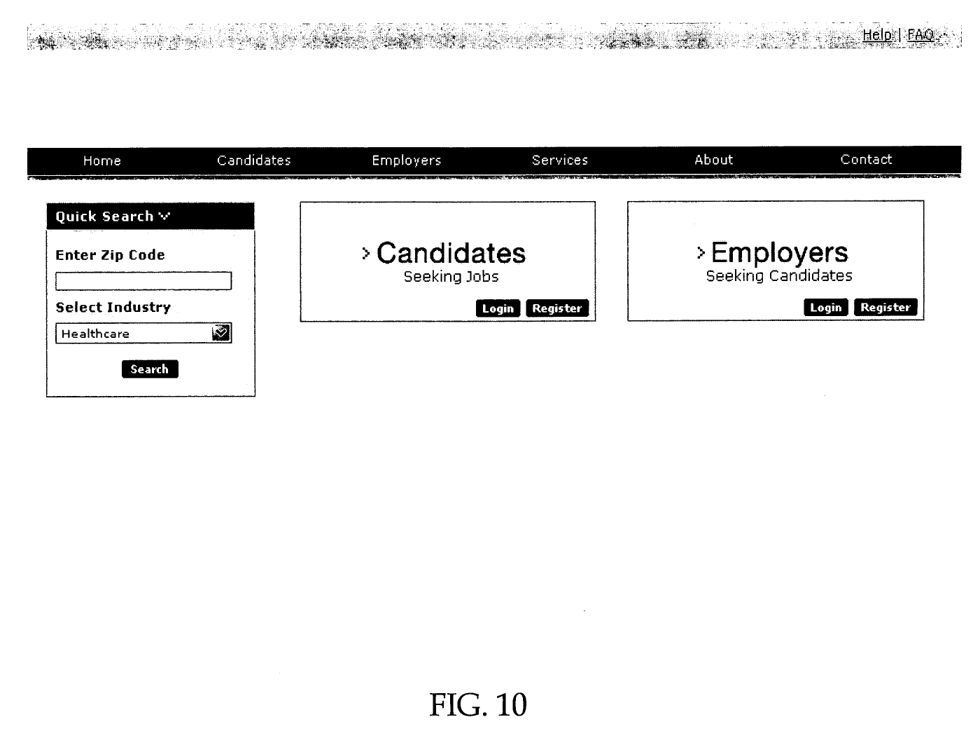

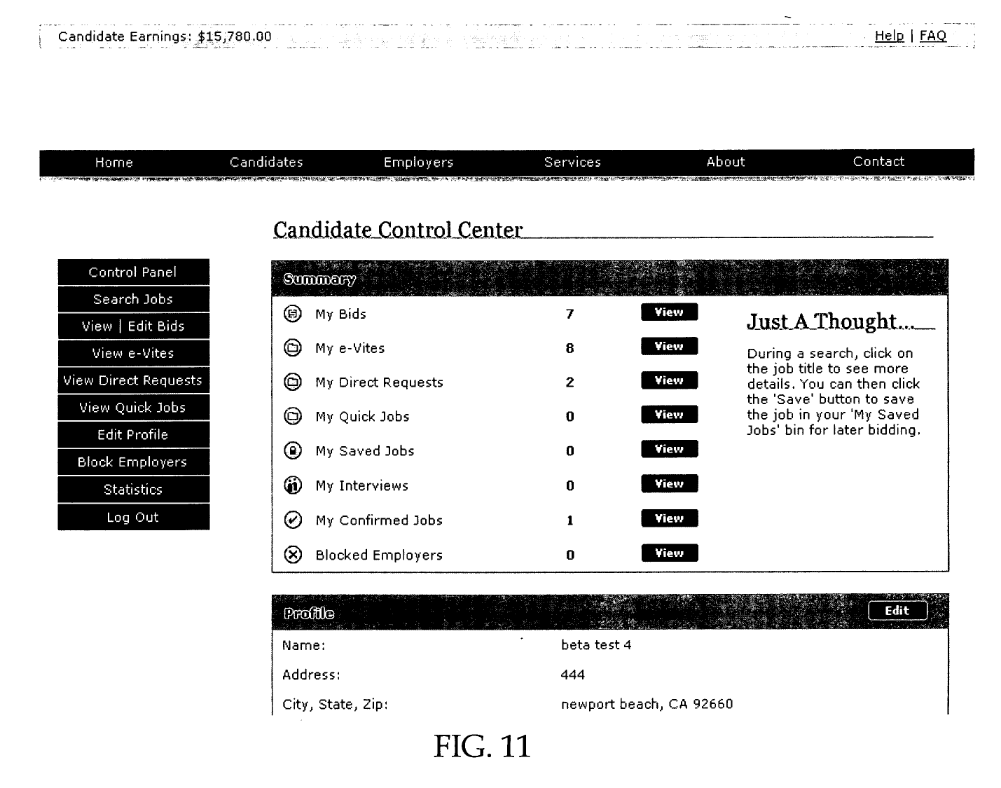

FIGS. 10-18 show screen shots illustrating a system of the invention from the user interface perspective. FIG. 10 shows an initial page or home page that provides a means for registered users to login to the system. Separate login buttons are preferably provided for candidates and for employers. As will be understood from the description below, the general structure of the site preferably provides a “Candidates” side and an “Employers” side, and the user is directed to one or the other depending upon whether he has logged in as a candidate or an employer.

FIGS. 11-13 show examples of the user interface on the Candidate side. FIG. 11 shows a Control Panel page to which a candidate is directed after logging in. Using the navigation bar on this page, a candidate can navigate to a desired area of the site, e.g., to pages which provide means for the user to search and bid upon jobs, view and edit bids, view e-Vites, view Direct Requests, view Quick Jobs, edit their user profile, block employers, view statistics, and log out from the system. A candidate's user profile is collected in a well-known manner, preferably when the candidate first registers on the system, and may include information such the user's full name, username, password, address, e-mail address, other contact information, shift preferences, certifications (RN, MD, LPN, etc), degrees (B.S., M.S., etc.) whether the candidate is available for “Quick Jobs” (discussed below), minimum hourly wage the candidate would accept, preferred job type (part time, full time, shift, etc.), lead time in days required (e.g., candidate would require 2 days lead time before agreeing to fill a shift), and a date when the candidate will become available to work. Each candidate's profile information is stored in a database that is searchable by employers registered on the system.

The Control Panel page of FIG. 11 also provides a “Summary” area which summarizes the results of the user's activities on the site and allows the user to view details of such activities if desired. The Summary area may include outstanding bids the user has made, any e-Vites he has received, any direct requests he has received, any quick jobs he has received, etc. The “My confirmed jobs” icon may flash or otherwise be highlighted if the candidate has been awarded a job and declared a winner.

As discussed above, e-Vites provide an employer with a proactive means by which it can send to a prospective candidate an invitation to bid on a posted position. In the example shown in FIG. 11, the Summary area indicates that this particular user has been invited to bid on 8 positions at this time. Clicking on “View” next to that number would display the details of these positions and provide the user with a means to submit a bid on one or more of the positions.

The Summary area shown in FIG. 11 further includes an indication of the number of Direct Requests the user has received. As described above, Direct Requests are similar to e-Vites in that they provide a proactive vehicle for employers to reach out to qualified candidates. However, Direct Requests allow the employer and the candidate to bypass the bid process. While e-Vites include a message inviting a number of users to bid on a position, Direct Requests are an actual offer, including a compensation level or hourly wage, to one or more qualified candidates and the first candidate to “accept” the Direct Request typically is awarded the job without having to complete a bidding process. In the example of FIG. 11, the user has received 2 Direct Requests and he can review and accept these requests by clicking on the “View” button next to that number.

The Summary area shown in FIG. 11 further includes an indication of the number of “Quick Jobs” which have been offered to the candidate. Quick Jobs is essentially an expedited version of the Direct Request. With the Direct Request, typically there is a two or three-week window between the date that the request is sent and the start date of the position. Quick Jobs, on the other hand, is a tool for use by employers seeking to fill a more immediate position, e.g., one in which the start date is the next day. As with Direct Requests, the first candidate to accept is typically awarded the position. When registering with the system or updating their user profile, candidates are provided with a means to indicate whether they are available for Quick Jobs and how much lead time they require for such positions. The system is preferably configured such that when an employer searches the system to identify qualified candidates for a particular Quick Job, the search results will be limited to those candidates whose user profile indicates that they are available within the lead time associated with the particular job.

The Summary area shown in FIG. 11 further includes an indication of the number of interviews notices which potential employers have sent to the candidate. If an employer has decided that it desires an interview with the candidate before making a final decision to hire the candidate, the employer may use the system to send an interview notice to the candidate. The interview notice may include, e.g., a time, a date, employer's contact person, and location of the requested interview. In the example shown in FIG. 11, the candidate has 0 interview requests. When a number other than 0 appears in this field, the user may then click on the “View” button next to that number to review and then accept or reject the request(s).

The Summary area shown in FIG. 11 further includes an indication of the number of Confirmed Jobs that have been awarded to the candidate. After a candidate has been notified that he is the winning bidder or otherwise has been awarded a job (e.g., through a Direct Request), the candidate is given another final opportunity to confirm, i.e. accept or reject, the job. In this respect, the system may be configured such that the “My Confirmed Jobs” icon shown in FIG. 11 is flashing or otherwise highlighted if there jobs which have been awarded to the candidate but which still require this final confirmation. Clicking on the icon brings the candidate to a screen at which such confirmation can be performed.

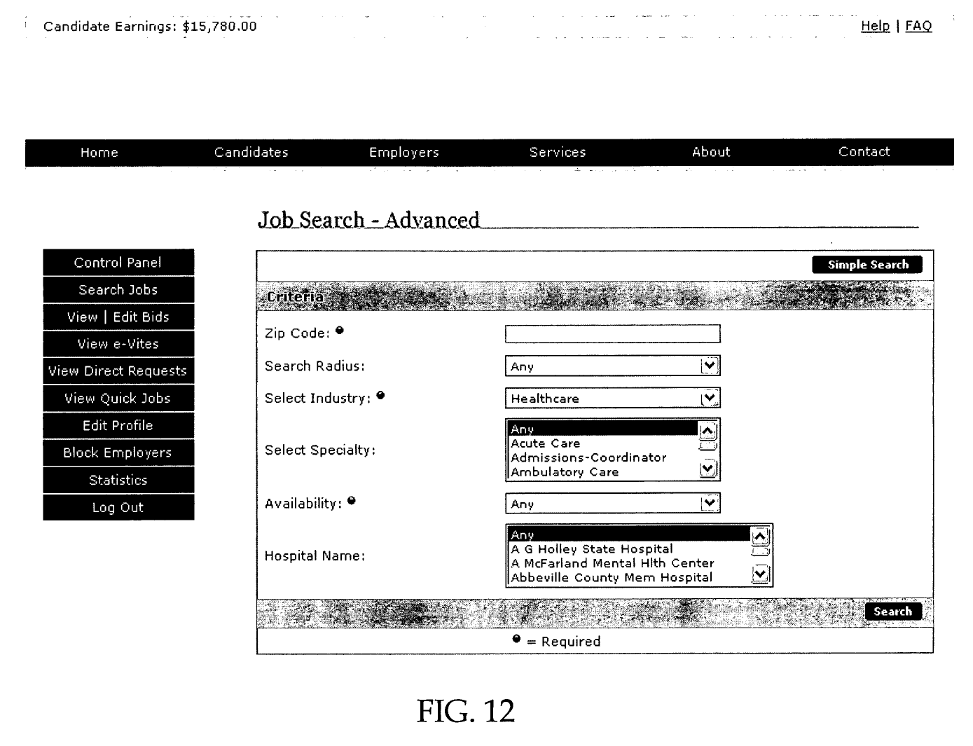

FIG. 12 shows a “Search Jobs” page which can be used by the candidate to locate open job positions which meet his criteria. This page provides a means for the candidate to enter his search criteria into any of several job search fields, including, e.g., a zip code and radius around the zip code, the industry and specialty within the industry, the availability associated with the job (e.g., part-time, full-time, or shift), and the particular employer. Once the candidate's search criteria are entered into these fields, the candidate can click the Search button to view resulting positions that meet the search criteria, and bid upon resulting positions which are attractive.

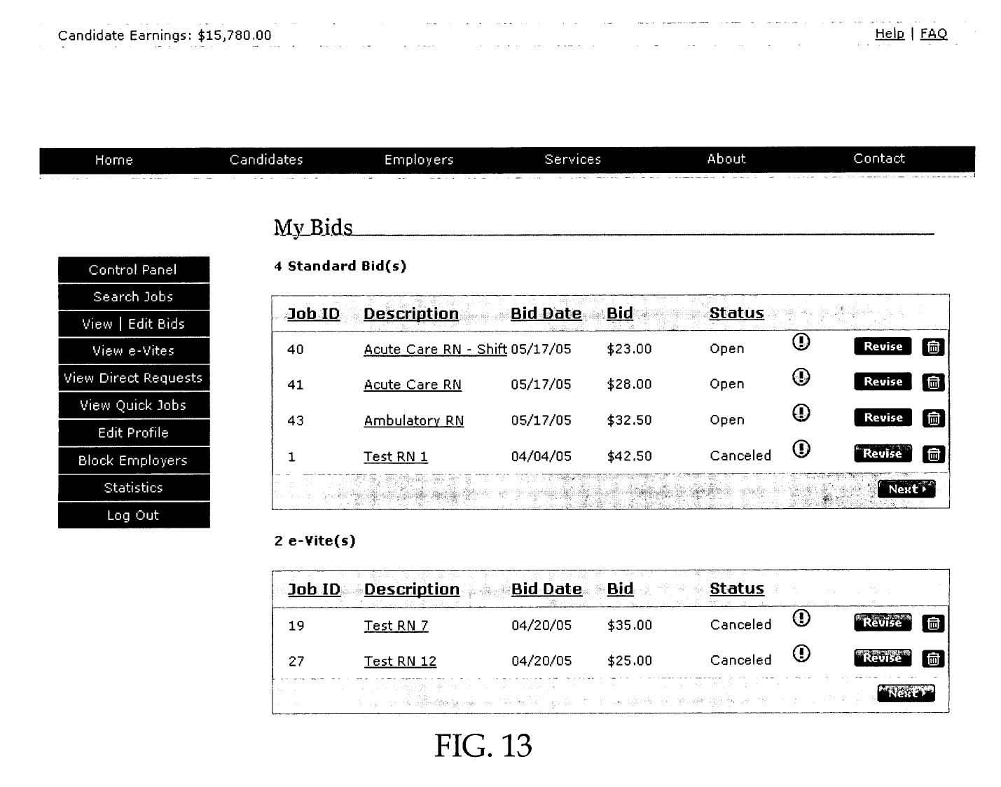

FIG. 13 shows a “View/Edit Bids” page which provides the candidate with an overview of bids previously made by the candidate for job positions. This page preferably lists only jobs which are either still open or cancelled. Once a job is filled, its status is changed to “closed” and it no longer will appear in the candidate's “My Bids” list. Each job listed is associated with a unique Job ID which is used throughout the system to identify that particular listing. The candidate can click the description for a particular job to view the details, and the page provides a “Revise” button for each job that brings the candidate to a screen that allows him to revise his bid. The system does not display to a particular candidate the wage that other candidates have bid on the particular job or a current low bid from other candidates, thereby preventing the candidate from ascertaining such wage.

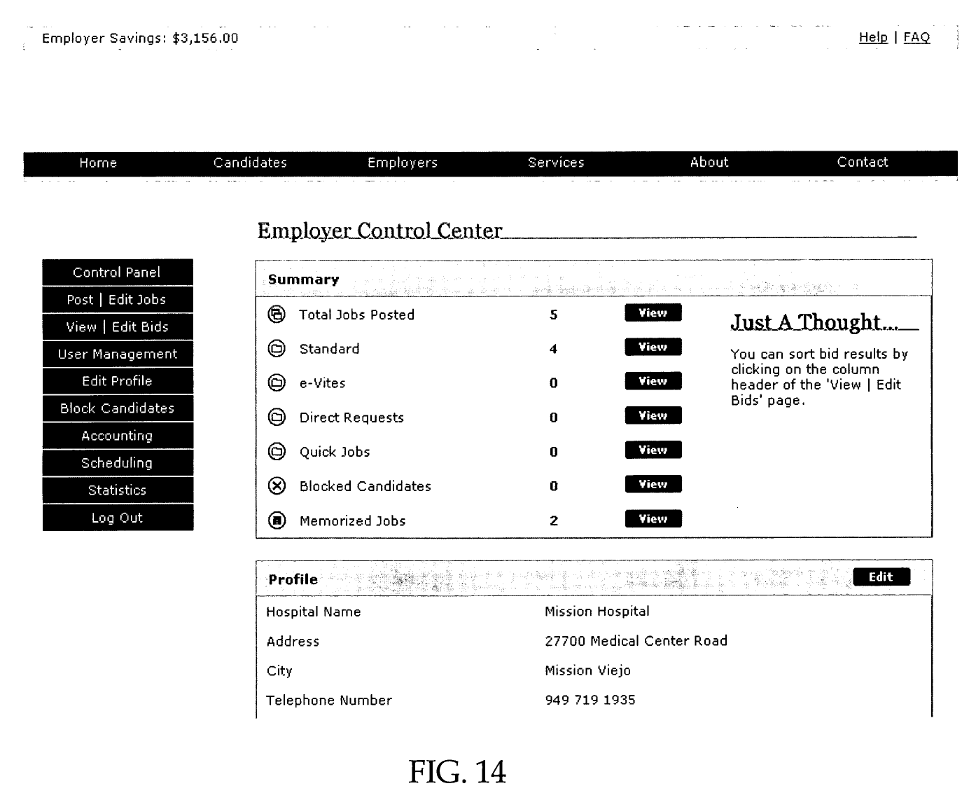

FIGS. 14-18 show examples of the user interface on the Employer side. FIG. 14 is a Control Panel page to which an employer is brought upon login. The employer's Control Panel page includes much the same type of functionality as is described above with reference to the candidate's Control Panel page of FIG. 11. The employer's Control Panel page may further include an estimation of the dollar amount saved by virtue of the employer's use of the system as opposed to a standard registry or agent fee. See, e.g., FIG. 14, upper left corner. The employer's Control Panel page may also include an indication of the number of “Memorized Jobs” that have been set up on the system by the employer. A Memorized Job is typically a job description and other criteria for a job position which is repetitively listed by the employer over time. In this respect, via the Memorized Jobs function the system allows the employer to, for example, use the same criteria and job description several times over the course of six months rather than re-entering the same criteria and description each time he desires to post the position.

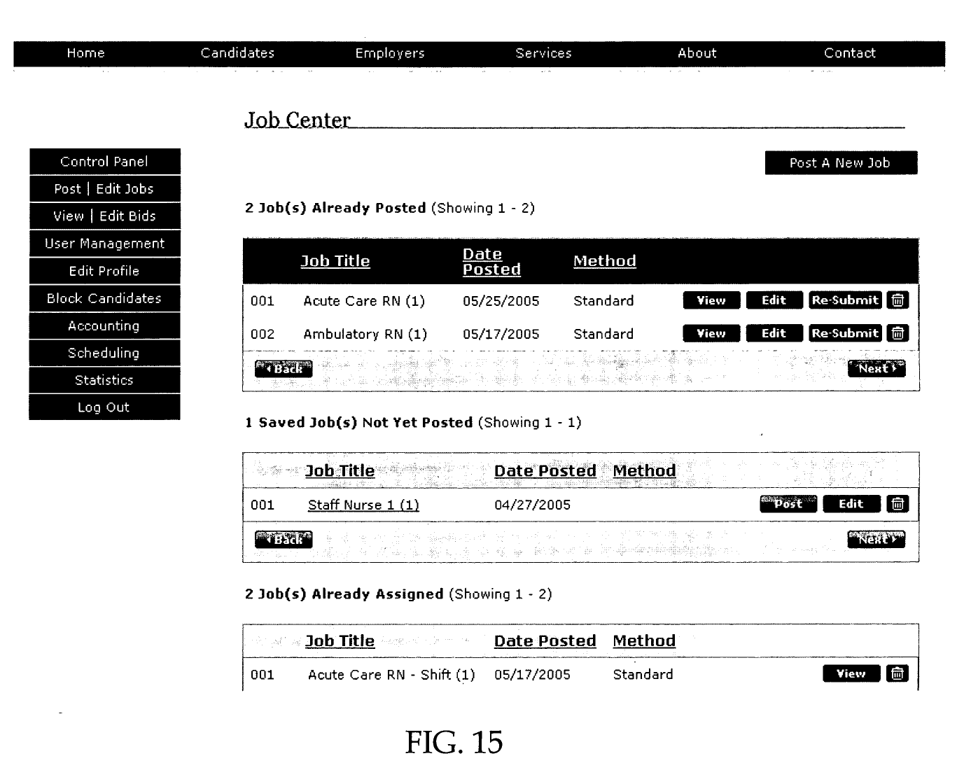

FIG. 15 shows a “Post/Edit Jobs” screen which provides a means for the employer to create and post a new job listing or edit one which has already been posted or partially created. The screen also preferably lists jobs which have already been assigned to a candidate by virtue of the candidate posting a “winning” bid or accepting a Direct Request or Quick Job invitation. A “Resubmit” button is preferably provided to allow an employer to re-post a job which no candidate has accepted. The re-submit function may be utilized to re-send e-Vites, Direct Requests, and Quick Job notifications to potential candidates. In this respect, the employer can either re-send the same notification to the same group of candidates or revise the notification or recipient list.

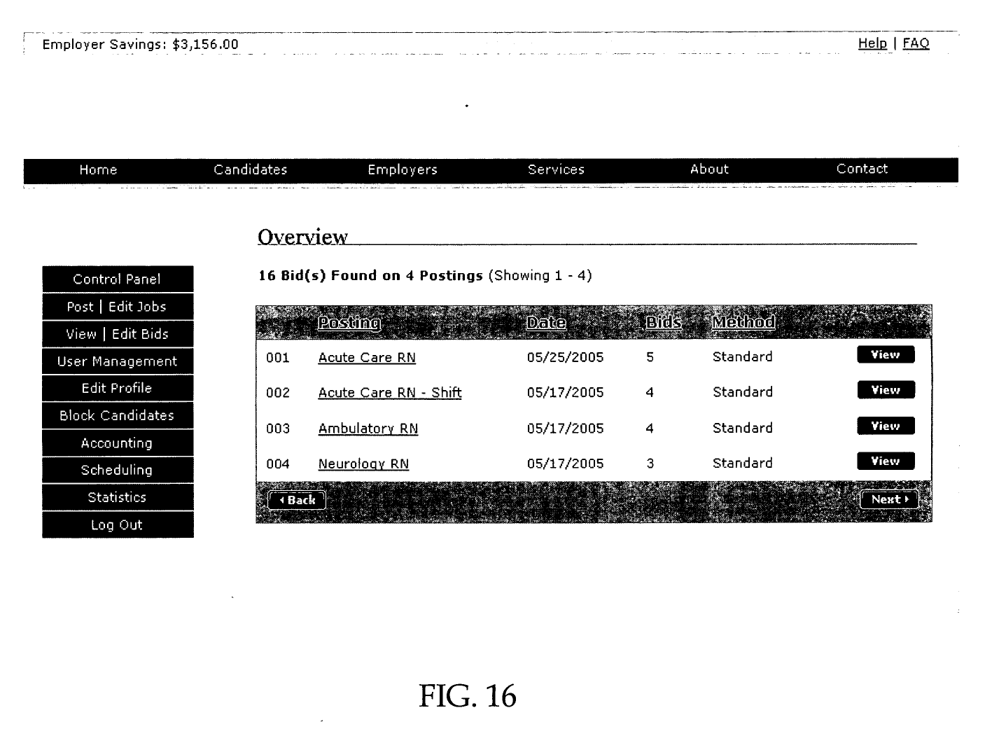

FIG. 16 shows a “View/Edit Bids” screen which provides a means for an employer to view all the bids they have received for the jobs it has listed. In this example, the employer has posted four jobs, and these have received 5, 4, 4 and 3 bids respectively. From this page the employer can click the “view” button to the right of each job to view the specific candidates that have bid upon the job, and then make a determination as to accept, reject, or interview each bidding candidate.

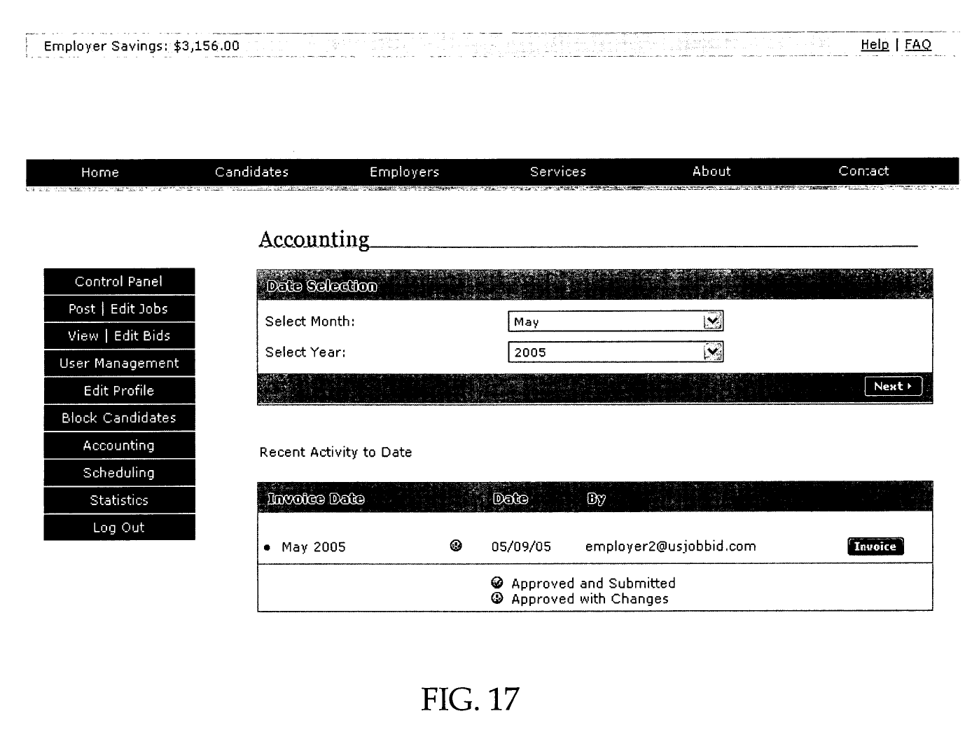

FIG. 17 shows an “Accounting” screen which provides an employer with a means to view invoices from the system proprietor for the employer's use of the system. The system may be configured to add a set charge each time a candidate is confirmed for a posted job position. Charges may also be based upon the number of hours worked by successful candidates, a monthly subscription rate, or other known business model. Once the employer selects the month and year of interest, the system displays information such as a list of positions posted by the employer during that month, an identification of each candidate which filled those positions, each successful candidate's bid, the number of hours worked by the candidate, and the charges charged by the system proprietor for its services in connection with filling the position. The system preferably provides an edit function, whereby the employer can then edit information such as the number of hours actually worked by a successful candidate. Upon approval of the edit by the system proprietor, the employer's invoice is adjusted accordingly. A rating feature may also be provided whereby the employer can rate each successful candidate so as to inform future decisions by the employer on the candidate.

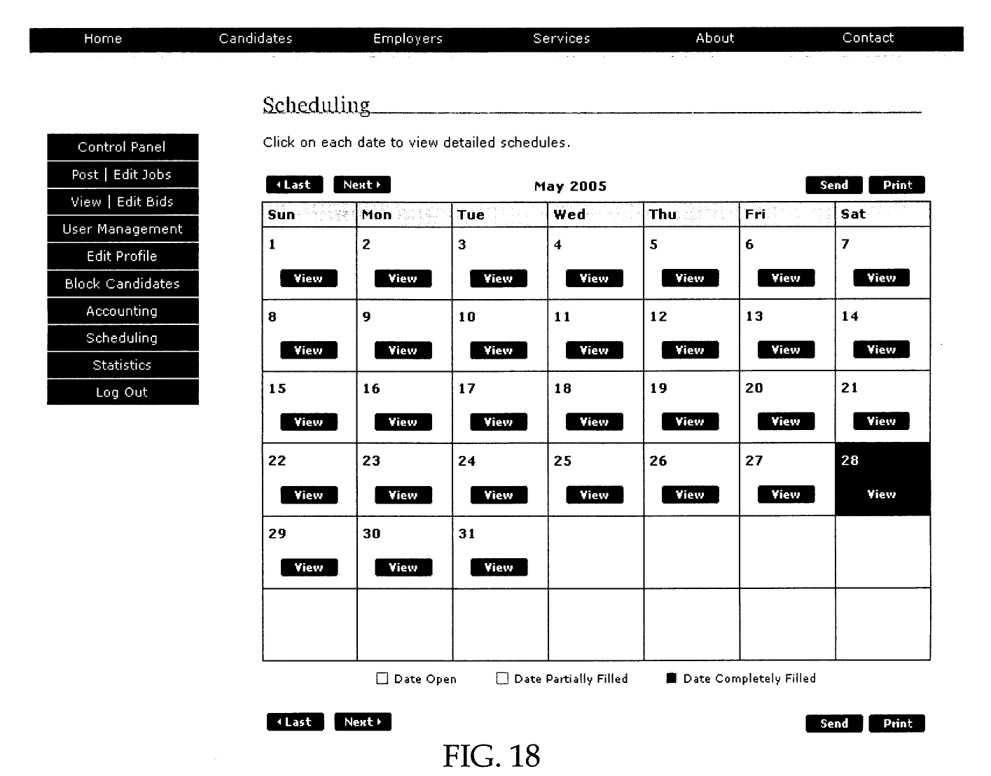

FIG. 18 shows a “Scheduling” screen which provides a means for the employer to view a central calendar wherein a date is highlighted if it is one on which one or more positions posted by the employer need to be filled or have already been filled by the system. When an employer posts jobs on the system and as those jobs are filled, the calendar is automatically updated by the system. In the example shown, May 28 is highlighted as a date on which one or more positions have been filled by the system. By clicking the “view” button associated with such date, the employer can view details of the position(s) to be filled. The Scheduling function is useful for allowing Human Resources personnel at an employer to efficiently manage the filling of upcoming shifts, part-time positions, or full-time positions.

While the invention has been described in detail and with reference to specific embodiments thereof, it will be apparent to those skilled in the art that various changes and modifications can and will be made therein without departing from the spirit and scope thereof. Thus, it is intended that the present invention cover the modifications and variations of this invention provided they fall within the spirit and the scope of the invention as described herein.

What is claimed is:

1. A method for filling employment positions using a closed bidding system, comprising the steps of:
displaying to a candidate via a computer network at least one identification of an employment position at an employer;
receiving from said candidate an indication of a bid amount comprising a minimum wage which said candidate would be willing to receive in exchange for filling said employment position;
displaying to a representative of said employer via said computer network a plurality of bids received from a corresponding plurality of candidate bids for said employment position;
receiving from said employer via said computer network a selection of at least one candidate to fill said employment position;
wherein said candidate is prevented from receiving information from the system via said computer network which would permit said candidate to ascertain bid amounts of other candidates which have submitted bids for said employment position prior to said selection of at least one candidate by said employer.

2. The method for filling employment positions using a closed bidding system in accordance with claim 1, further comprising the steps of:
storing in a database information regarding qualifications of said plurality of candidates;
displaying to said representative of said employer said information regarding qualifications of said plurality of candidates prior to said step of receiving from said employer via said computer network a selection of at least one candidate to fill said employment position.

3. The method for filling employment positions using a closed bidding system in accordance with claim 1, further comprising the step of:
receiving from each of said plurality of candidates information regarding qualifications of each candidate; and, storing said information regarding qualifications of each candidate in a database.

4. The method for filling employment positions using a closed bidding system in accordance with claim 3, further comprising the step of:
providing a search function which permits said employer to search said information regarding qualifications of each candidate in said database.

5. The method for filling employment positions using a closed bidding system in accordance with claim 4, further comprising the step of:
providing an electronic invitation function whereby said employer can send an invitation-to-bid to candidates identified by said employer using said search function.

6. The method for filling employment positions using a closed bidding system in accordance with claim 3, wherein said information regarding qualifications of each candidate comprises an indication of certifications held by each candidate.

7. The method for filling employment positions using a closed bidding system in accordance with claim 1, wherein said step of receiving from each of said plurality of candidates information regarding qualifications of each candidate is performed in conjunction with registration of each candidate as a user of the system.

8. The method for filling employment positions using a closed bidding system in accordance with claim 1, further comprising the step of:
Storing in a user profile an indication of whether said candidate is available for short-lead-time jobs.

9. The method for filling employment positions using a closed bidding system in accordance with claim 1, further comprising the step of:
storing in a user profile an indication of whether said candidate is willing to accept direct requests from employers to fill an employment position and a minimum wage which said candidate would be willing to accept in exchange for filling said employment position.

10. The method for filling employment positions using a closed bidding system in accordance with claim 1, further comprising the step of:
receiving from said employer an indication that the employer desires an interview with said candidate;
sending an automated electronic interview notification to said candidate in response to receiving said indication that the employer desires an interview with said candidate.

11. A method for filling employment positions using a direct request from an employer, comprising the steps of:
storing in a database an indication that a candidate is willing to accept direct requests from employers to fill an employment position;
storing in said database information regarding qualifications of said candidate;
displaying to a representative of said employer said information regarding qualifications of said candidate;
receiving from said employer via said computer network a selection of said candidate to fill said employment position;
using a computer system and said database to send an automated electronic message to said candidate indicated that said employer has selected said candidate to fill said employment position; and,
using said computer system to receive a confirmation from said candidate that said candidate will fill said employment position.

12. The method for filling employment positions using a direct request from an employer according to claim 11, wherein said automated message to said candidate includes an indication of a wage which said employer is willing to pay said candidate in exchange for filling said employment position.

13. The method for filling employment positions using a direct request from an employer according to claim 11, further comprising the step of storing in said database a minimum wage which said candidate would be willing to accept in exchange for filling said employment position.

14. The method for filling employment positions using a direct request from an employer according to claim 11, wherein said automated message to said candidate includes a job description, a wage being bid by said employer for filling said employment position, and a date when the employment position is available.

15. The method for filling employment positions using a direct request from an employer according to claim 14, wherein said automated message to said candidate further includes a shift time of said employment position.
